(19) United States
(12) Patent Application Publication
(10) Pub. No.: US 2008/0223533 A1
(43) Pub. Date: Sep. 18, 2008

(54) Armor system for field protection and a method for making same

(75) Inventors: Norman Andreasen, New Milford, NJ (US); John L. De Cristofaro, Warren Township, NJ (US); John Anthony Dispenza, Long Valley, NJ (US); Leon Klafter, Brielle, NJ (US); Richard Thomas LaGrotta, Livingston, NJ (US)

Correspondence Address: Michael G. Fletcher;Fletcher Yoder PC, P.O. Box 692289, Houston, TX, 77269-2289, US

(73) Assignee: Lucent Technologies Inc.

(21) Appl. No.: 11/717,958

(22) Filed: Mar. 14, 2007

(51) Int. Cl. E99Z 99/00

(52) U.S. Cl. 160/351

(57) ABSTRACT

The present techniques include a field armor system comprising hollow structures designed to be filled with field materials, such as soil, sand, rocks, or clay. At least one face of the structures is made from a projectile resistant plastic composite. The projectile resistant plastic composite panel may be made from a ceramic plastic composite, a fiber plastic composite, or interspersed layers of both. In one embodiment, the hollow structure comprises four connected panels that may be collapsed when empty. In another embodiment, the hollow structure may comprise hollow bricks designed to interlock to form a protective wall.

### BACKGROUND OF THE INVENTION

1. Field of the Invention

The present techniques relate to armor protective systems for field protection. Specifically, the armor protective systems are made from hollow structures having a projectile resistant front face.

2. Description of the Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Protection from projectile impact is a critical need in many military and civilian situations. Such protection may take a number of forms, including personal protective equipment, armored vehicles, armored housing, and field fortifications. Each of these types of protection serves an important function, but may not cover all of the needs for protection from projectiles.

Personal protective equipment, such as helmets, bullet resistant vests, or body armor, may protect against many threats, but may not be practical for continuous use. Such equipment is also limited in the protection that it can afford by the size and weight that a person can carry. Further, such protective equipment may not cover the entire surface of the person, leaving some parts, such as the arms and legs, vulnerable to injury.

Armored vehicles provide a higher level of protection, but are usually limited in interior space, which may limit the number of persons that may be protected. Further, armored vehicles may be a high value target and may still be vulnerable to high level threats, such as armor piercing rounds.

Armored housing may be made from reinforced panels, which may be bolted together in the field to form enclosures. Although these systems may provide another type of protection in addition to the previously discussed systems, panels that are sufficiently strong to protect from high impact threats may be too heavy for widespread use in the field.

Another technique that may be used for protection against projectile threats is the construction of field fortifications. These fortifications are usually made by digging into the ground to form earthen works, such as soil berms, trenches, tunnels, or foxholes. While these techniques are effective at protecting personnel from projectiles, they may take a significant amount of time to construct. Furthermore, such fortifications are not portable and must be rebuilt at each new site. Additionally, the geography of the location in which the fortification is needed may make construction difficult, if not impossible. For example, in dry desert environments, loose sand or soil may not have enough cohesive strength for tunnels or foxholes. Rocky environments may pose other problems, since explosives may be required to create field fortifications.

For these reasons, developmental efforts have continued to identify field fortification techniques or equipment that may be easily and widely deployed, and which will provide significant protection in a short period of time.

### SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

One embodiment of the present techniques provides a field armor system having a structure made from at least four vertical surfaces enclosing a space. At least one of the vertical surfaces is made from a projectile resistant plastic composite panel. In at least one dimension the space is from greater than about 2″ to less than about 18″. In one aspect, the projectile resistant plastic composite panel is made from a blend of ceramic particles and a plastic matrix. In another aspect, the projectile resistant plastic composite panel is made from fibers embedded in a plastic matrix. In yet another aspect, the projectile resistant plastic composite panel is made from adjacent layers of a ceramic plastic composite and a fiber plastic composite.

Another embodiment provides a method of manufacturing a field armor system. The method comprises providing a structure from at least four vertical surfaces enclosing a space. At least one of the vertical surfaces is made from a projectile resistant plastic composite panel. In at least one dimension the space is from greater than about 2″ to less than about 18″.

Another embodiment provides a method for protecting persons and equipment from projectiles. The method comprises erecting a structure having at least four vertical surfaces enclosing a space. At least one of the vertical surfaces is made from a projectile resistant plastic composite panel. In at least one dimension the space is from greater than about 2″ to less than about 18″. The space is filled with soil, sand, clay, or rocks.

### BRIEF DESCRIPTION OF THE DRAWINGS

Advantages of the invention may become apparent upon reading the following detailed description and upon reference to the drawings in which:

FIG. 1 is a perspective view of a field armor unit that has a projectile resistant plastic composite panel for a front face and is designed to be filled with field materials in accordance with embodiments of the present techniques;

FIG. 2 is a perspective view of a projectile resistant plastic composite panel, comprising ceramic particles in a plastic matrix in accordance with embodiments of the present techniques;

FIG. 3 is a perspective view of a projectile resistant plastic composite panel, comprising fibers in a plastic matrix in accordance with embodiments of the present techniques;

FIG. 4 is a perspective view of a projectile resistant plastic composite panel comprising layers of plastic containing fibers and layers of plastic containing ceramic particles in accordance with embodiments of the present techniques;

FIG. 5 is a top view of a structure having a front face made from a projectile resistant plastic composite panel and containing fill in a hollow center section, showing the effects of multiple projectile impacts, in accordance with embodiments of the present techniques;

FIG. 6 is a perspective view of a hollow block having a projectile resistant plastic composite panel for a front face and is designed to be filled with field materials in accordance with embodiments of the present techniques; and

FIG. 7 is a perspective view of a protective wall constructed from hollow blocks that have been filled with field materials in accordance with embodiments of the current invention.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

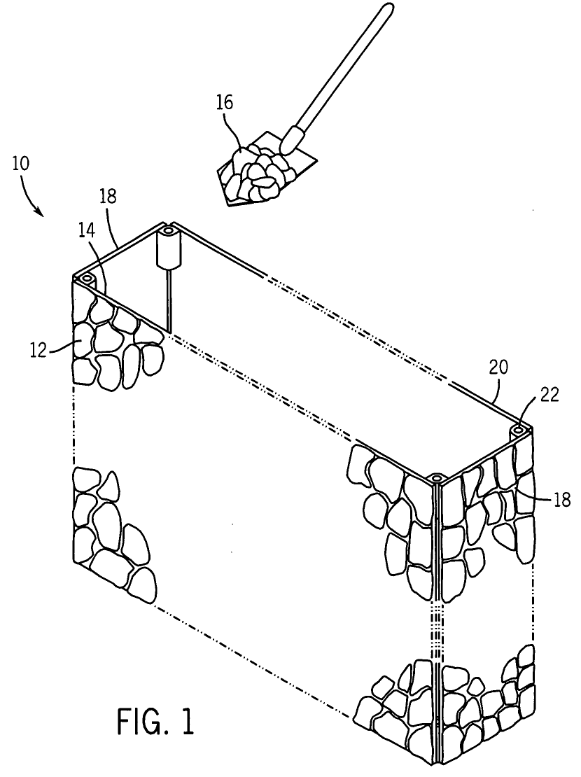

The present techniques include hollow structures 10 that may have at least a front face 12 made from a projectile resistant plastic composite panel 14, as shown in FIG. 1. These hollow structures 10 may contain field materials for fill 16, such as sand, dirt, or rock. The use of fill 16 may increase the projectile resistance of such hollow structures 10, which may decrease the thickness and weight required for the projectile resistant plastic composite panel 14. These lighter weight structures may be more portable than other types of field armor.

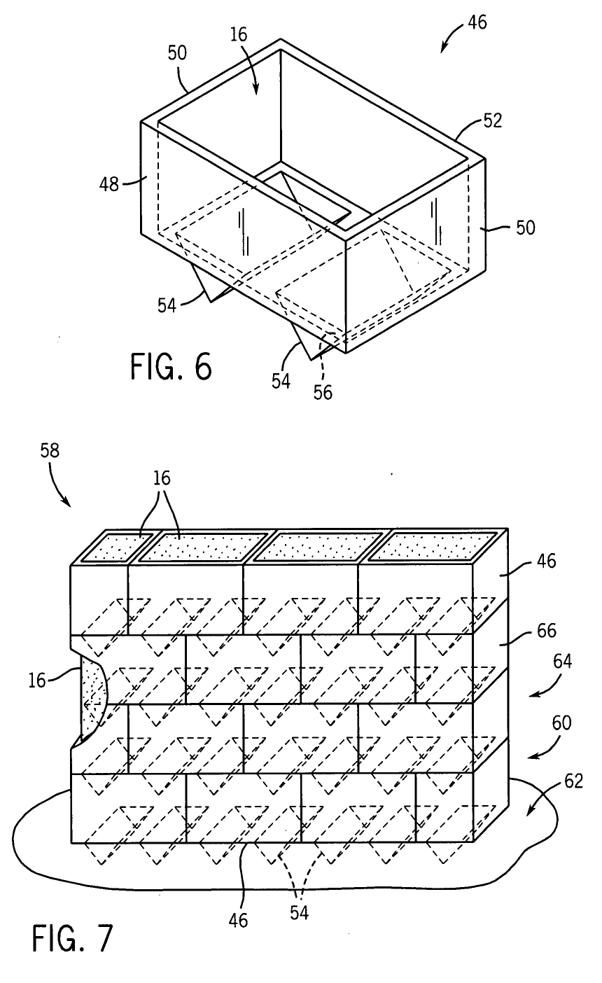

The hollow structures 10 may be made, for example, by connecting the front face 12 to side panels 18, and connecting the side panels 18 to a rear panel 20 to form an enclosed space. In embodiments of the present techniques, the enclosed space may be between about 2″ to about 18″ deep. In embodiments of the present techniques, the front face 12 is the only part comprising a projectile resistant plastic composite panel 14. In other embodiments, the side panels 18 or the rear panel 20 may comprise projectile resistant plastic composite panels 14 in addition to, or instead of, the front face 12. Hinges 22 made be used to connect the front face 12 to the side panels 18, and to connect the side panels 18 to the rear panel 20, allowing the hollow structure 10 to be collapsed flat when not in use. Alternatively, the panels could use pressure fit connectors in place of hinges 22, allowing the panels to be completely separated and snapped together in the field. Those skilled in the art will recognize that other techniques, such as gluing the panels, may be used to join the panels together while remaining within the scope of the disclosure. Further, other configurations may be used for the hollow structures 10, as discussed with respect to FIG. 6.

The projectile resistant plastic composite panels 14 may comprise any number of plastic composite structures. For example, plastic composite structures that may be used in embodiments of the current invention include ceramic plastic composite panels, fiber plastic composite panels, or multi-layered panels. Such composites may allow the projectile resistant plastic composite panels 14 to be lighter in weight than other types of armor, such as, for example, metal plate. Further, plastic composite structures may be more durable than armor made from ceramic plates, e.g., resistant both to physical impacts, such as being dropped during construction, and to multiple projectile impacts.

### Ceramic Plastic Composite Panels

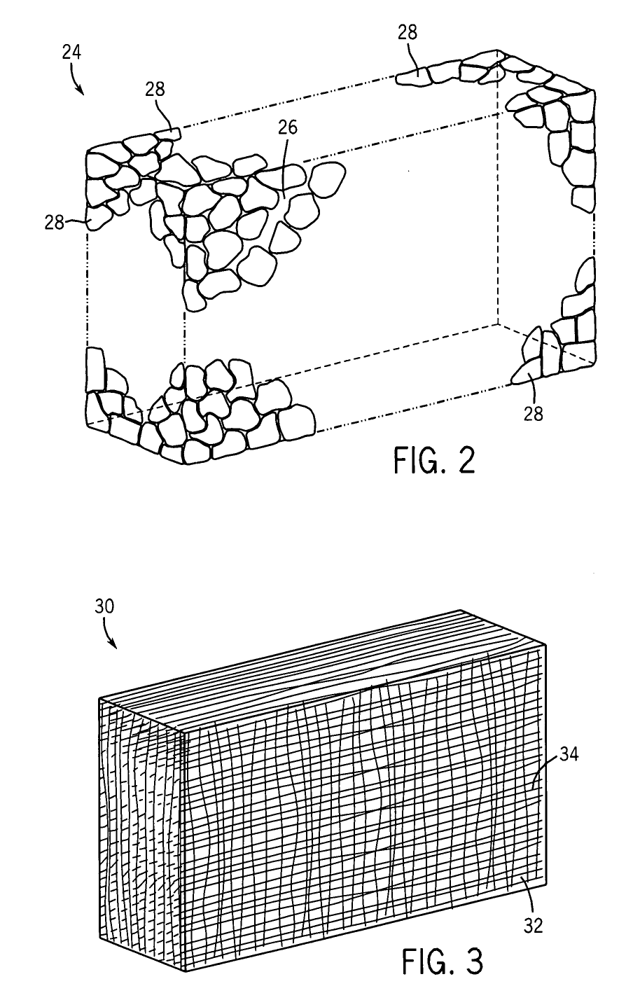

The projectile resistant plastic composite panels 14 may comprise a ceramic plastic composite panel 24. As shown in FIG. 2, the ceramic plastic composite panel 24 may be made from a blend of ceramic particles 28 and a plastic matrix material 26. The ceramic particles 28 may comprise at least 50% by volume of the ceramic plastic composite panel 24 and may comprise as much as 90% of the ceramic plastic composite panel 24.

The choice of the plastic matrix material 26 depends on the performance characteristics desired. For example, the plastic matrix material 26 may either be a thermoplastic or a thermoset depending on the molding or recycling properties needed. Thermoplastics that may be used in embodiments of the present techniques, include, by way of example, polycarbonate, polyphenylene sulfide (PPS), poly(ether ether ketone) (PEEK), styrene butadiene copolymers, acrylonitrile butadiene styrene (ABS) copolymers, polyurethanes, polyamides, or various combinations thereof.

Alternatively, if the of recycling or reuse of the plastics is not desired, a thermoset plastic may be used for the plastic matrix material 26. Thermoset materials that may be used in embodiments of the present techniques include, by way of example, epoxy resins, vulcanized rubber, polyurethanes, polyamides, or combinations thereof, depending on the properties needed.

Furthermore, additives may be blended into the plastic matrix material 26 to improve the performance of the ceramic plastic composite panel 24. Examples of such additives include stabilizers and flow enhancers, among others. For example, stabilizers may be added to improve the oxidative resistance of the ceramic plastic composite panel 24, which may increase the useful lifespan of the projectile resistant plastic composite panels 14. Such stabilizers may include hindered phenolic stabilizers, such as Irganox 1010 or Irganox 1076, available from CIBA Corporation, among others. Other oxidative stabilizers may be added, including such stabilizers as tris-nonyl phenol phosphite (TNPP), other phosphites, or cyclic lactides, among others.

Further, flow agents may be added to the plastic matrix material 26 to improve the wetting of the ceramic particles 28. Improved wetting of the ceramic particles 28 may reduce the formation of voids, resulting in improvements in the performance of the ceramic plastic composite panel 24. For example, polycarbonate may have a very high melt viscosity, resulting in poor flow around the ceramic particles 28. Lower viscosity resins may be used, but these may have lower impact strength. The addition of a macrocyclic poly(butylene terephthalate) (PBT), such as CBT®, available from Cyclics® Corporation, may lower the melt viscosity, which may lead to lowering the number of voids formed in the matrix.

In addition to the plastic matrix material 26, the other major components of the ceramic plastic composite panel 24 are the ceramic particles 28. The ceramic particles 28 may be selected from ceramic materials, including, by way of example, alumina, boron carbide, boron nitride, silicone carbide, silicone nitride, magnesium silicate, magnesium oxide, titanium carbide, titanium oxide, tungsten carbine, zirconia, or combinations of these materials. The selection of the material may be made on the basis of factors such as the threat protection needed and the overall cost of the structure. For example, alumina particles may provide the lowest overall cost, but harder materials, such as boron carbide, may provide more effective protection in thinner structures.

The size of ceramic particles 28 may range from greater than 100 micrometers to less than 10,000 micrometers, for example. A wide particle size distribution may improve the performance of the panel in two ways. While larger particles may be more effective at stopping projectiles, smaller particles may improve the packing efficiency in the matrix. Improved packing of the ceramic particles 28 may lead to a higher concentration of ceramic particles 28 in the plastic matrix material 26. This higher concentration will increase the number of particles a projectile encounters upon impact, increasing the chances of fragmenting and slowing the projectile. Furthermore, improved packing may place more ceramic particles 28 in direct contact with each other, which may distribute the force of the impact over a wider area.

In embodiments of the present technique, the ceramic particles 28 may comprise shapes ranging from spheres to random rough fragments. In one embodiment, the ceramic particles 28 may comprise flat particles, which may be aligned with the flat surfaces parallel to each other and to the impact surface of the ceramic plastic composite panel 24. Alignment of the flat ceramic particles 28 may be achieved by taking advantage of the shear force resulting from polymer flow during the molding process to align the particles. The use of flat particles may increase the surface area of the ceramic particles 28 encountered by a projectile upon impact. This may provide a further advantage over round or rough ceramic particles 28 by distributing the force over a wider area. Furthermore, the use of flat particles may increase the number of particles that a projectile will need to shatter to penetrate the armor, versus other shapes of ceramic particles 28 that may be pushed aside by a projectile.

### Fiber Plastic Composite Panels

Another structure that may be used for projectile resistant plastic composite panels 14 in embodiments of the present techniques is shown in FIG. 3, which illustrates a fiber plastic composite panel 30. The fiber plastic composite panel 30 may be made from a second plastic matrix material 32 containing embedded fibers 34. Selection of the second plastic matrix material 32 is performed as described above for the plastic matrix material 26 used in the ceramic plastic composite panel 24, and the same materials and additives may be used.

The fibers 34 used to form the fiber plastic composite panel 30 may be made from any sufficiently strong material, including: glass; metal; polyamides; polyaramides, such as Kevlar®, available from DuPont, or Dyneema®, available from DSM; carbon fibers; polyolefins, such as Spectra®, available from Honeywell; polyurethanes; polyamide copolymers; poly(p-phenylene-2,6-benzobisoxazole), available as Zylon® from Toyobo; or combinations thereof. If the fibers 34 are made from metal, a number of metals may be chosen, including titanium, steel, or any other metal that may be used to form a fiber with the appropriate weight and strength characteristics. Such alternate metals may include manganese alloys, among others. The choice of the fibers 34 may depend on the performance and cost desired. For example, a fiber plastic composite panel 30 made using fibers 34 comprising a titanium mesh may provide high protection in a thinner fiber plastic composite panel 30, but may not be as cost effective as other choices used to make a thicker fiber plastic composite panel 30 giving the same protection.

The fibers 34 may be embedded in the second plastic matrix material 32 as a woven mesh or alternatively, may be used a non-woven fabric material. The choice of a woven fiber mesh or a non-woven fabric will depend on the strength and properties of the fiber plastic composite panel 30 desired.

### Multilayered Composite Panels

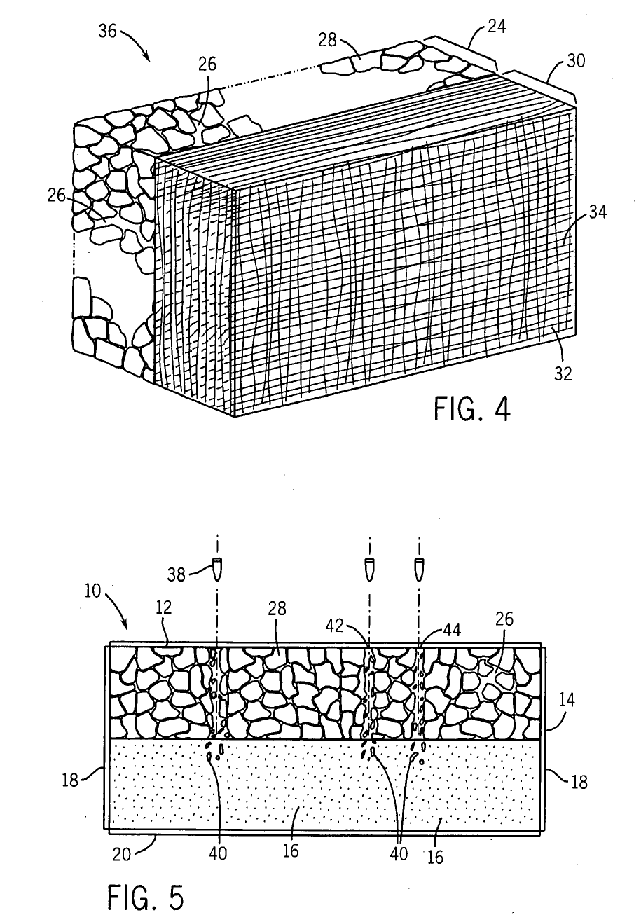

Either the ceramic plastic composite panel 24 or the fiber plastic composite panel 30 described above may be used in hollow structures 10 for protection from lower impact threats. Still higher protection from projectile penetration may be achieved by joining layers of the ceramic plastic composite panel 24 with layers of the fiber plastic composite panel 30 to form a multilayered panel 36, as shown in FIG. 4. The resulting multilayered panel 36 may be comprised of one or more layers of the ceramic plastic composite panel 24 combined with one or more layers of the fiber plastic composite panel 30. The layers do not have to be sequential, e.g., with the ceramic plastic composite panel 24 on one side and the fiber plastic composite panel 30 on the other side, but may have different layers having different compositions interspersed therein.

The multilayered panel 36 can be assembled by pressing together one or more layers of the ceramic plastic composite panel 24 with one or more layers of the fiber plastic composite panel 30, using layers of thermoplastic to hold the panels together. This may be performed by placing the individual panels into a mold with layers of thermoplastic separating the individual composite layers. The mold is closed and heated under high pressure, melting the thermoplastic between the layers and forming a multilayered panel 36. Alternatively, a multilayered panel 36 may be formed by either bonding the individual panels together with an adhesive or by physically holding the panels together with a frame.

### Example of Impact Protection

The hollow structures 10 of the present techniques may provide protection from penetration of a structure by multiple high velocity projectiles. Without intending to be limiting, an example of how such protection may be achieved is shown in FIG. 5. As seen in this figure, a hollow structure 10 is made having a front face 12 made from a projectile resistant plastic composite panel 14. As illustrated, the projectile resistant plastic composite panel 14 may be a ceramic plastic composite material 24 having ceramic particles 28 dispersed in a plastic matrix 26. Alternatively, the front face 12 may be a fiber plastic composite panel 30 or a multilayered panel 36. Side panels 18 are attached to the front face 12, and a rear panel 20 is attached to the side panels 18, creating a hollow space. This space may be filled with sand, soil, rocks, clay or other fill 16.

When a bullet 38 strikes the hollow structure 10, it is slowed and may be fragmented by the structure of the projectile resistant plastic composite panel 14. The bullets fragments 40 may then be stopped in the fill 16, preventing penetration of the hollow structure 10. As the projectile resistant plastic composite panel 14 is not a single plate, multiple projectiles may have closely spaced impact 42, 44 without affecting materials not in immediate proximity to the impacts sites 42, 44. This lessens the chance that multiple impacts may penetrate or cause failure of the hollow structure 10. Further protection may be afforded if the rear panel 20 is also made from a projectile resistant plastic composite panel 14.

### Alternate Configurations for Field Protection Structures

The hollow structure 10, discussed with respect to FIG. 1, is one of a number of possible configurations that may be used in embodiments of the present techniques. An alternate configuration is shown in FIG. 6. In this embodiment, a brick structure 46 is formed having a front face 48, side faces 50, and a rear face 52. In embodiments of the present techniques, the front face 48 is the only part comprising a projectile resistant plastic composite panel 14. In other embodiments, the side faces 50 or the rear face 52 may comprise projectile resistant plastic composite panels 14 in addition to, or instead of, the front face 48. The brick structure is hollow for adding fill 16, such as soil, sand, rocks, or clay. The brick structure 46 may have protrusions 54 that extend from the bottom surface 56 to allow the brick structure 46 to interlock with other brick structures 46. The protrusions 54 may be tapered to allow for easier insertion into the ground or into the fill 16 material contained in the other brick structures 46.

The individual brick structures 46 may be used to construct a protective wall 58, as shown in FIG. 7. The protective wall 58 may be made by pushing a line 60 of individual brick structures 46 into the ground 62, and adding fill 16 to the hollow cavities of the brick structures 46. A second line 64 of brick structures 46 is placed on top of the first line 60, offset by one half of a brick structure 46. The protrusions 54 of the brick structures 46 of the second line 64 are then pushed into the fill 16 contained in the brick structures 46 of the first line 60, until the brick structures 46 of the second line 64 are in direct contact with the first line 60. Successive layers are added in this way until the protective wall 58 is sufficiently tall. Structures comprising half bricks 66 may be used at the sides of the wall to support bricks 46 above.

It should be understood that the present techniques have been described above by way of example and that such techniques may apply in other situations as well. Indeed, the present techniques may prove useful in situations other than protecting persons from projectiles in battlefield situations. For instance, the hollow structures 10 of the present techniques may be useful for protecting fuel, ammunition, and equipment bunkers. Further, the low cost of the hollow structures 10 may make the use of ballistic protection practical for situations where a ballistic threat is improbable, but of high consequence. For example, the hollow structures 10 of the present techniques may be used for protection during events in geographic locations where terrorist attacks are more likely to occur. Further, the hollow structures 10 of the present techniques may be used for the protection of electronics housings in remote locations, such as, for example, cellular telephone antenna towers located in rural sites.

While the invention may be susceptible to various modifications and alternative forms, specific embodiments have been shown by way of example in the drawings and/or described in detail herein. However, it should be understood that the invention is not intended to be limited to the particular forms disclosed. Rather, the invention is to cover all modifications, equivalents, and alternatives falling within the spirit and scope of the invention as defined by the following appended claims.

We claim:

1. A field armor system comprising a structure comprising at least four vertical surfaces enclosing a space, wherein at least one of the vertical surfaces comprises a projectile resistant plastic composite panel; and wherein in at least one dimension the space is from greater than about 2″ to less than about 18″.

2. The field armor system of claim 1 wherein the space is filled with at least one of rock, soil, sand, clay, or combinations thereof.

3. The field armor system of claim 1 wherein the projectile resistant plastic composite panel comprises a blend of ceramic particles and a plastic matrix material, and wherein the ceramic particles comprise at least 50% by volume of the blend.

4. The field armor system of claim 3 wherein the plastic matrix material comprises a thermoplastic material.

5. The field armor system of claim 4 wherein the thermoplastic material comprises at least one of a polycarbonate, a poly(phenylene sulfide), a poly(ether ether ketone), a styrene butadiene copolymer, a acrylonitrile-butadiene-styrene (ABS) copolymer, a polyurethane, a polyamide, or combinations thereof.

6. The field armor system of claim 3 wherein the plastic matrix material comprises a thermoset material.

7. The field armor system of claim 6 wherein the thermoset material comprises at least one of an epoxy, a vulcanized rubber, a polyurethane, a liquid crystalline polymer, a polyamide, or combinations thereof.

8. The field armor system of claim 3 wherein the ceramic particles have a size range from greater than about 50 micrometers to less than about 10,000 micrometers.

9. The field armor system of claim 3 wherein the ceramic particles comprise at least one of alumina, boron carbide, boron nitride, silicon carbide, silicon nitride, magnesium silicate, magnesium oxide, titanium carbide, titanium oxide, tungsten carbide, zirconia, or combinations thereof.

10. The field armor system of claim 3 wherein the ceramic particles comprise at least 80% of the blend.

11. The field armor system of claim 3 wherein the ceramic particles comprise flat particles.

12. The field armor system of claim 3 wherein the flat particles are aligned substantially parallel to a surface.

13. The field armor system of claim 3 wherein the projectile resistant plastic composite panel comprises a plastic matrix material comprising embedded high strength fibers.

14. The field armor system of claim 13 wherein the plastic matrix material comprises a thermoplastic material.

15. The field armor system of claim 14 wherein the thermoplastic material comprises at least one of a polycarbonate, a poly(phenylene sulfide), a poly(ether ether ketone), a styrene butadiene copolymer, a acrylonitrile-butadiene-styrene (ABS) copolymer, a polyurethane, a polyamide, or combinations thereof.

16. The field armor system of claim 13 wherein the plastic matrix material comprises a thermoset material.

17. The field armor system of claim 16 wherein the thermoset material comprises at least one of an epoxy, a vulcanized rubber, a polyurethane, a liquid crystalline polymer, a polyamide, or combinations thereof.

18. The field armor system of claim 13 wherein the high strength fibers comprise at least one of glass fibers, metal wire, polyaramid fibers, ultra high molecular weight polyethylene fibers, carbon fibers, copolyaramid fibers, polyurethane fibers, or combinations thereof.

19. The field armor system of claim 1 wherein the projectile resistant plastic composite panel comprises at least two layers, wherein at least one layer comprises a blend of ceramic particles and a plastic matrix material, the ceramic particles comprising at least 50% by volume of the layer, and at least one other layer comprising high strength fibers in a second plastic matrix material.

20. The field armor system of claim 1 wherein the vertical surfaces comprise: a front panel, two side panels joined to the front panel, and a rear panel joined to the two side panels; and wherein the structure is configured to be collapsed or disassembled when empty.

21. The field armor system of claim 1 wherein the vertical surfaces comprise at least a front face, a rear face, and two side faces, wherein all faces are permanently joined to a bottom surface to form a hollow brick, and wherein the bottom surface comprises projections to engage other hollow bricks.

22. The field armor system of claim 20 wherein the projections on the lower surface of the hollow block are tapered.

23. A method of manufacturing a field armor system comprising:
providing a structure comprising at least four vertical surfaces enclosing a space, wherein at least one of the vertical surfaces comprises a projectile resistant plastic composite panel, and wherein in at least one dimension the space is from greater than about 2″ to less than about 18″.

24. The method of claim 23 comprising forming the projectile resistant plastic composite panel from a blend of ceramic particles and a plastic matrix material, wherein the ceramic particles comprise at least 50% by volume of the blend.

25. The method of claim 23 comprising forming the projectile resistant plastic composite panel from a plastic matrix material comprising embedded high strength fibers.

26. The method of claim 23 comprising forming the projectile resistant plastic composite panel from at least two adjacent layers, wherein at least one layer is formed from a blend of ceramic particles and a plastic matrix material, wherein the ceramic particles comprise at least 50% by volume of the blend; and at least one other layer formed from high strength fibers embedded in a plastic matrix material.

27. The method of claim 23 connecting the vertical surfaces together with hinges to allow the structure to be collapsed when not empty.

28. The method of claim 23 comprising connecting the vertical surfaces together with pressure fit connectors to allow the structure to be disassembled when not empty.

29. The method of claim 23 comprising permanently joining the vertical surfaces to a each other and a bottom surface to form a hollow brick, and wherein the bottom surface comprises projections to engage other hollow bricks.

30. A method for protecting persons and equipment from projectiles comprising:
erecting a structure comprising at least four vertical surfaces enclosing a space, wherein at least one of the vertical surfaces is made from a projectile resistant plastic composite panel, and wherein in at least one dimension the space is from greater than about 2″ to less than about 18″; and
filling the space with soil, sand, clay, or rocks.

31. The method of claim 30 wherein the projectile resistant plastic composite panel comprises at least one of a layer comprising a blend of ceramic particles and a plastic matrix material, a layer comprising a plastic matrix material comprising embedded high strength fibers, or combinations thereof.
